(19) United States
(12) Patent Application Publication
(10) Pub. No.: US 2009/0068610 A1
(43) Pub. Date: Mar. 12, 2009

(54) DENTAL BRACKETS OR ATTACHMENTS AND METHODS AND DEVICES FOR USING THE SAME

(76) Inventor: NAPHTALI BREZNIAK, Tel-Aviv (IL)

Correspondence Address: DANIEL J SWIRSKY, 55 REUVEN ST., BEIT SHEMESH, 99544, IL

(21) Appl. No.: 12/265,040

(22) Filed: Nov. 5, 2008

Related U.S. Application Data
(63) Continuation of application No. 11/515,212, filed on Sep. 1, 2006.
(60) Provisional application No. 60/713,374, filed on Sep. 2, 2005.

(51) Int. Cl. A61C 7/14

(52) U.S. Cl. 433/9

(57) ABSTRACT

A method of attaching an orthodontic attachment to a patient's tooth with a photo-sensitive adhesive includes placing the attachment with a photosensitive adhesive applied thereto against a surface of the patient's tooth with the photosensitive adhesive in contact with the tooth and transmitting light through a solid, transparent portion of the appliance to initiate curing of the photo-sensitive adhesive to adhere the attachment to the tooth.

### CROSS-REFERENCE TO RELATED APPLICATIONS

This application is a continuation of U.S. patent application Ser. No. 11/515,212, filed Sep. 1, 2006, which claims priority from U.S. Provisional Patent Application No. 60/713,374, filed Sep. 2, 2005.

### TECHNICAL FIELD

The invention relates to improvements in orthodontic brackets and in particular to an improved methods and apparatus for attaching brackets to a patient's teeth.

### BACKGROUND OF THE INVENTION

Orthodontics, the first specialty in dentistry, is the practice of moving teeth to resolve functional and aesthetic problems. Moving teeth is done by adding attachments, brackets and a band to the outer surfaces of the teeth. For many years, the attachments were soldered to metal round strips that were formed chair side by the clinician and later bonded to the teeth using zinc-phosphate cement. This procedure was extremely lengthy and time consuming.

A breakthrough came in the late 1960's and early 1970's with the invention of composite bonding materials. These materials eliminated much of the need for soldering attachments, especially those on the ten front teeth in either jaw. Brackets are now bonded directly to the front or rear surfaces of these teeth. The composites that were initially developed were mainly self-curing in a chemical process initiated upon mixing when two or more materials in which monomers and polymers are united to form a final material strong enough to bond the attachment to the tooth.

A drawback to the use of self-curing adhesives is that once the materials are mixed, there is no way to stop the curing process as it runs from initiation to termination. Users of self-curing materials had to be experts in the process and exactly time the mixing step. Once a self-curing adhesive is mixed and applied to the attachment, the attachment must be accurately placed on the tooth in three dimensions and held for several seconds until the material has cured sufficiently to prevent the attachment from sliding. Sliding can easily change the critical position of the attachment on the tooth.

Another milestone in the development of bonding materials was the use of light-cure bonding materials. Light curing systems allow the user to place the attachment on the tooth and then initiate the curing process by applying light to the adhesive. Immediately after the light hits the bonding material, it initiates to cure and the orthodontist can move to another tooth. No mixing of materials is required.

Although self-curing adhesives for orthodontic attachments such as brackets, tubes and other attachments are probably more popular than any other bonding system, the use of light-cured adhesives is growing due to a number of factors. New light sensitive bonding materials have been developed that can easily replace self curing adhesives due to their excellent properties. Light curing systems have been also applied in other areas of dentistry. New residents, the future orthodontists, are exposed to light curing systems in dental schools. Light curing systems are also suited to attaching different materials to teeth for cosmetic reasons.

Polymerization and curing of a bonding adhesive is a chemical process that may be initiated by heat, UV or visible light, or special chemical materials. There are several mechanisms involved in the polymerization process. The most prevalent mechanism is free radical polymerization with unsaturated molecules containing double bonds between the carbon atoms. The reaction takes place in three stages initiation, propagation and termination. The process is initiated by forming free radicals that combine with other monomers or polymers. The process propagates when free radicals and the free electrons shift to the end of the growing chain. When no more free radicals are present, the chemical process terminates.

The most popular material for orthodontic bonding is the Bis-GMA. (bisphenol A and two molecules of glycidyl methacrylate: “2,2-bis[4(2-hydroxy-3-methacryloyloxy-propyloxy)-phenyl]propane.” This material is an oligomer (not a monomer) that polymerizes through the free process described above. Since both ends of the Bis-GMA molecule have double bonds, the material polymerizes to form a highly cross linked polymer. Different chemicals may be added to achieve different composite qualities, for example, making the compound more or less liquid.

In the process of light curing, the free radicals are generated by exposing the adhesive containing a special photo initiator to visible light. One such photo initiator is diketone-amine known generically as camphorquinone (CQ) which reacts to visible light, particularly blue light in the 470 nm wavelength range. There are other chemicals used to produce free radicals for the process of polymerization, however these are less popular.

The development of new light sources has decreased the curing time from about a minute to several seconds. New appliances and light sources have been developed to make the orthodontist's chair side work easier and faster. Light curing devices currently on the market include UV light devices, tungsten-halogen devices with special filters, plasma devices, argon laser devices and LEDs (light emitting diodes). The advantage of these new devices is faster curing of the adhesive. A disadvantage of currently used devices is that the more than one person is required to position the device and initiate the curing process. Typically, the orthodontist positions the bracket or other attachment at the desired location on the tooth with a tweezers or similar tool. With the bracket correctly positioned, the orthodontist signals or instructs his or her assistant to apply light to the adhesive to initiate the curing process. Consequently, the process requires four hands to insure that the bracket is held in the proper position until the adhesive is sufficiently cured to hold the bracket or attachment in place on the tooth.

Another recent development is dental jewelry. Currently, diamonds, pieces of gold, zirconium and similar materials are being bonded on the tooth surface for cosmetic purposes. It is not uncommon to see young and adult people wearing jewelry specially designed for bonding on the tooth surface. Different colors and configurations are popular among patients and others, where brackets are used for both orthodontic and for cosmetic purposes. The present invention addresses these areas.

### SUMMARY OF THE INVENTION

A method of attaching an orthodontic appliance to a patient's tooth with a photo-sensitive adhesive according to the invention includes positioning the appliance with a photosensitive adhesive applied thereto against a surface of the patient's tooth with the photosensitive adhesive in contact with the tooth, and then transmitting light through a light-transmitting portion of the appliance adjacent to the adhesive to initiate curing of the photosensitive adhesive to adhere the appliance to the tooth. The light can be emitted from a light source such as an LED positioned within the appliance or bracket, or can be transmitted into the bracket by means of the tool used to position it on the tooth.

Such a tool, in one form, is a tweezers or other type of mechanical bracket holding implement having a pair of arms with distal ends configured to grasp and position an orthodontic appliance on a patient's tooth. At least one light transmitter is exposed at a distal end portion of one the arms for supplying light to illuminate a photosensitive adhesive applied to the orthodontic appliance to adhere the appliance to the patient's tooth. In another form, electrical contacts exposed at the distal ends of the arms for supplying electrical current to a light source attached to the orthodontic appliance. This causes the light source to illuminate a photosensitive adhesive applied to appliance to adhere the appliance to the patient's tooth.

The invention further provides a decorative device adapted to be adhered to a tooth, e.g., tooth jewelry. Such a device includes a base adapted to be positioned against the wearer's tooth, a light source attached to the device for illuminating the device while the device is attached to the patient's tooth, and a power source for activating the light source. These and other aspect of the invention are discussed in the detailed description that follows.

### BRIEF DESCRIPTION OF THE DRAWINGS

In the accompanying drawing, like numerals denote like elements, and:

FIG. 1 is front perspective view of an orthodontic bracket in accordance with the invention;

FIG. 2 is a rear perspective view of the bracket of FIG. 1 showing the bottom surface of the bracket;

FIG. 3 is a partial cutaway view of the bracket of FIG. 2;

FIG. 4 is a perspective view of the bracket of FIG. 1 wherein a battery is incorporated into the bracket;

FIG. 5 is a perspective view of a bracket according to the invention wherein a light source in the bracket is connected to a power source separate from the bracket;

FIG. 6 is a rear perspective view of a bracket according to the invention illustrating electrical contacts for connecting a power source to the bracket;

FIG. 7 is a rear perspective view of a bracket according to the invention illustrating light-transmitting projections engagable using a tweezers;

FIG. 8 is a perspective view of an orthodontic tool according to the invention used to grasp the bracket of FIG. 6;

FIG. 9 is a perspective view of another orthodontic tool according to the invention used to grasp the bracket of FIG. 7;

FIG. 10 is an exploded view of the bracket of FIG. 7 and a further orthodontic tool according to the invention;

FIG. 11 shows the tool of FIG. 10 grasping the bracket;

FIGS. 12 and 13 are perspective views of additional tools according to the invention;

FIG. 14 is an exploded view of the tool of FIG. 10 and a modified orthodontic bracket according to the invention; and

FIG. 15 is a front view of a tooth jewelry item according to the invention.

### DETAILED DESCRIPTION

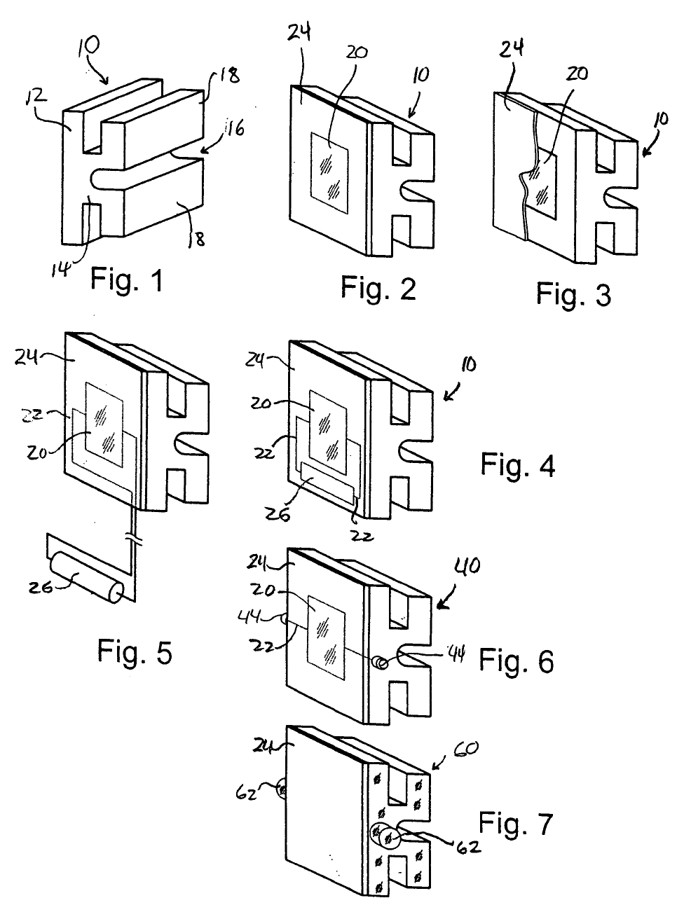

Referring to FIGS. 1-3, an orthodontic bracket 10 according to the invention includes a generally rectangular base 12 (but can be in any shape) having a flat or curved bottom surface, a central portion 14 extending from the base 12 and an arch wire slot 16 along the outer surface of central portion 12. A pair of tie wings 18 extend in an occlusal-gingival direction from central portion 14 generally parallel to base 12. Bracket 10 may be formed from a variety of metals, ceramics, plastics, composites or combinations of different materials. As such, bracket 10 may be opaque, translucent or transparent. Bracket 10 may be of any known type, i.e., single, twin, or self-ligating.

Bracket 10 includes a light source 20 embedded in the bottom of base 12 for curing a photo-sensitive adhesive applied to the bottom of the base 12. Light source 20 may be of any useful type such as a light emitting diode (LED), UV light, tungsten-halogen devices with special filters, plasma device, or argon laser that emits light within the frequency range required to initiate curing of the adhesive. Light source 20 is preferably covered with a transparent diffuser film or layer 24. Layer 24 may be formed from a transparent plastic or similar material suitable for transmitting and distributing light emitted from light source 20 to base 12 for curing a photo-sensitive adhesive applied to the base. Layer 24 also serves to enclose and protect light source 20 from contamination and may have an adhesive on its inner face for securing light source 20 in position in the manner of an adhesive tape.

While light source 20 is shown positioned next to base 12 of bracket 10, the light source could be positioned elsewhere in the bracket. If bracket 10 is formed from a transparent material, light source 20 may be positioned anywhere in the bracket so long as sufficient light is transmitted to base 12 to initiate curing. If bracket 10 is opaque, it may be necessary to position light source 20 as shown in FIGS. 2-3 to provide sufficient light to initiate curing, or else incorporate a piece of light transmitting material into the otherwise opaque bracket to transmit light from light source 20 to the base 12.

Electrical energy can be supplied to light source 20 in a variety of ways as described hereafter. Turning to FIG. 4, a battery 26 may be incorporated into bracket 10 to power light source 20 during installation, and thereafter for cosmetic or decorative purposes. As illustrated, battery 26 is embedded in bracket 10 and connected to the light source with leads 22. If no switch is provided, then to avoid draining the battery prematurely, the connection between leads 22 and battery 26 is not made until just prior to installation, requiring a pre-assembly step.

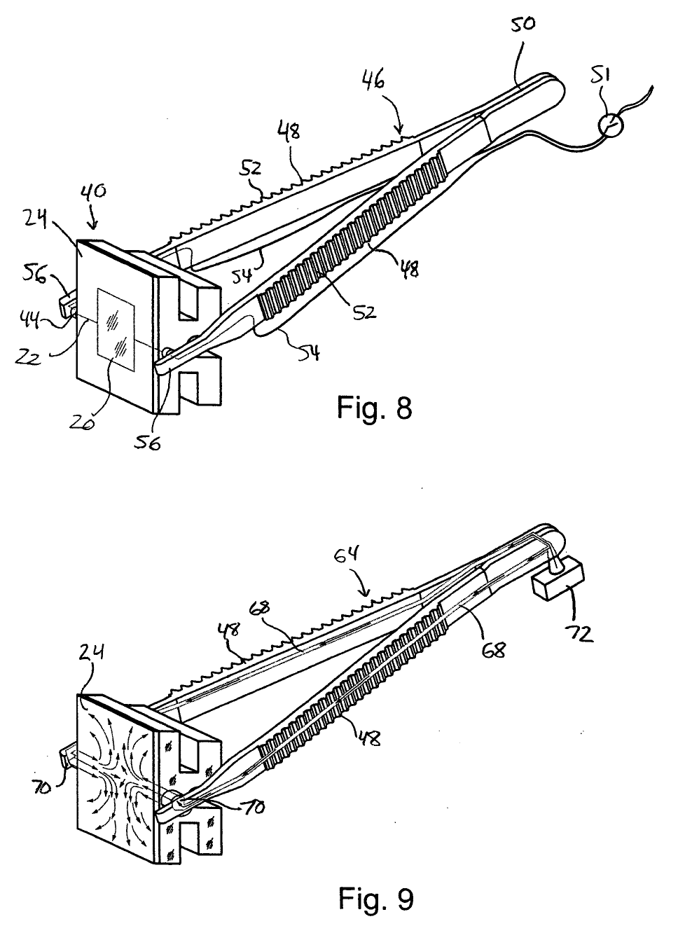

In applications wherein the purpose of light source 20 is to cure a light sensitive adhesive to attach the orthodontic device to a patient's tooth, an external power source is preferably used to activate the light source. As shown in FIGS. 6 and 8, a bracket 40 of the invention may be configured with an embedded light source 20 connected via leads 22 to a pair of pole-like contacts 44 (flat, recessed, indented or bulging) on opposite sides of the bracket body. Light source 20 illuminates when sufficient current is applied to contacts 44.

As shown in FIG. 8, an orthodontic tweezers 46 or bracket holder for grasping bracket 40 includes a pair of pair of flat, generally elongated arms 48 positioned in opposed lengthwise relationship and connected at proximal ends 50. Each of arms 48 include a series of external ridges 52 to aid the orthodontist in securely holding tweezers 46. A pair of electrical leads 54 extend along each of arms 48 to prong-like second distal ends 56 of arms 48. Leads 54 are connected to a suitable power source, such as a battery or power supply, and also to a pair of conductive pads or surfaces on ends 56, whereby the current flows through contacts 44 and light source 20 is illuminated. Contacts 44 allow an orthodontist to grasp and hold bracket 40 between arms 48 with ends 56 in electrical contact with contacts 44. For this purpose, the ends of contacts 44 may be flush with the sides of bracket 40, rather than projecting as shown.

To install bracket 40 on a patient's tooth, the orthodontist grasps the bracket 40 as illustrated in FIG. 8, applies a photosensitive adhesive to the outside of diffuser 24 (if the adhesive is not pre-pasted), and then positions the bracket 40 onto the patient's tooth with the adhesive in contact with the tooth. Once bracket 40 is properly positioned, the orthodontist activates a suitable switch 51, supplying electrical current through leads 54 to energize light source 20. The switch may be a conventional one mounted on tweezers 46, or may be remotely located and activated by voice command, the clinician's foot by means of a pedal, or the like. In this manner, the light for curing is applied at the correct moment without need of a human assistant for that purpose.

FIGS. 7 and 9 illustrate an embodiment of the invention where a bracket 60 made of a transparent or translucent material does not contain an internal light source 20. Bracket 60 has a pair of transparent cylindrical projections or poles 62 on opposite sides configured similarly to contacts 44. A pair of tweezers 64 is similar to tweezers 46 described above, but instead of electrical leads it has a pair of light conducting channels or optic fibers 68 running along arms 48 that terminate in transparent windows 70 (or special connectors). A light source 72 is mounted to optic fibers 68 at the proximal end of tweezers 64 and may include a built-in switching mechanism, e.g., the light is activated when the clinician presses on light source 72 or in a similar manner as described above. Light is then conducted through arms 48 and into the body of bracket 60. Diffuser 24 aids in distributing the light to the adhesive to promote curing.

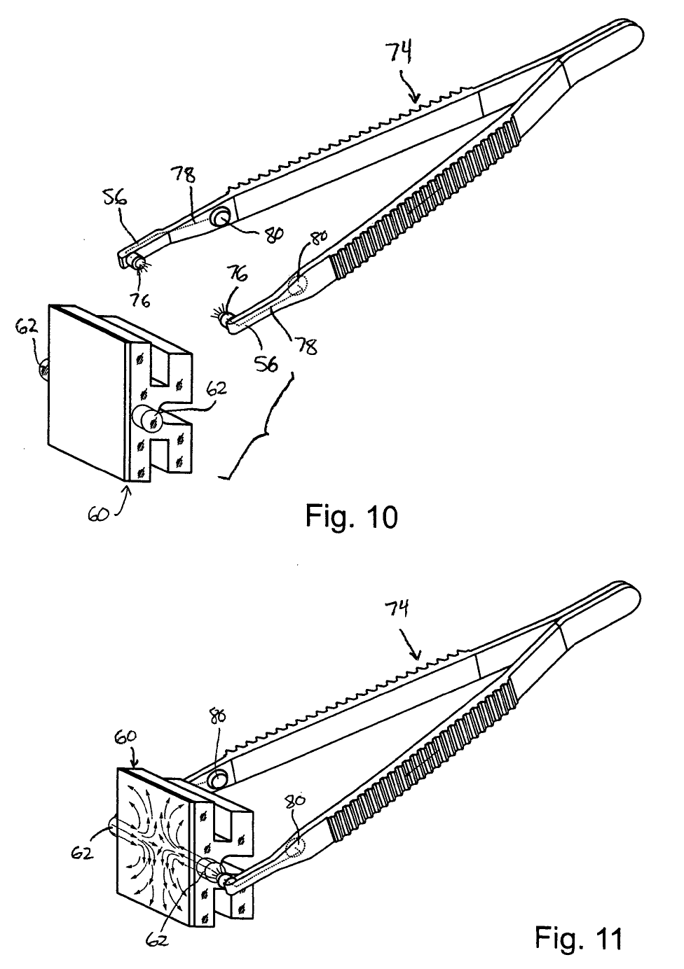

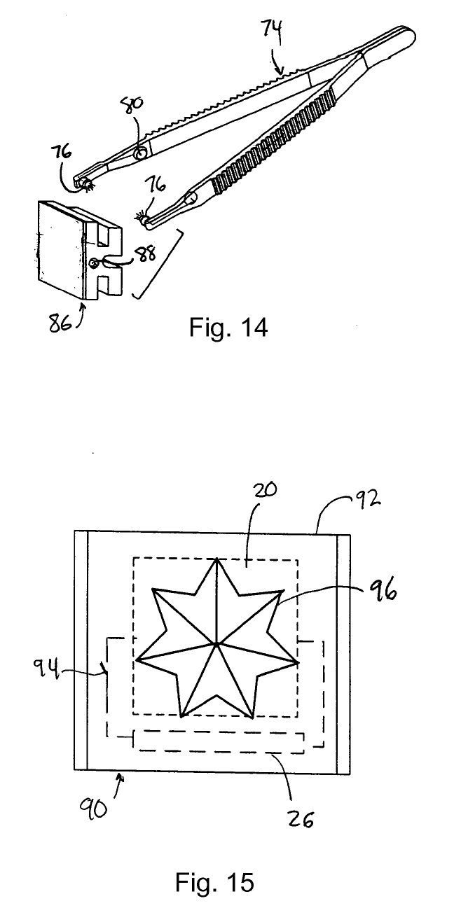

FIGS. 10 and 11 illustrate a further system for use with bracket 60. In this embodiment, tweezers 74 have a pair of LED's 76 on their distal ends 56. LED's 76 are connected by a pair of leads 78 to a pair of batteries 80 mounted on arms 48. As shown in FIG. 11, LED's 76 contact projections 62 and thereby illuminate bracket 60. An external switch, not shown, may be provided to activate LED's 76 as needed. In FIG. 14, tool 74 is used with a modified bracket 86 made of a transparent material wherein projections 62 are replaced by a corresponding pair of recesses 88 sized for LED's 76 to fit into. This arrangement provides better distribution of light and allows the bracket 86 to be held more securely.

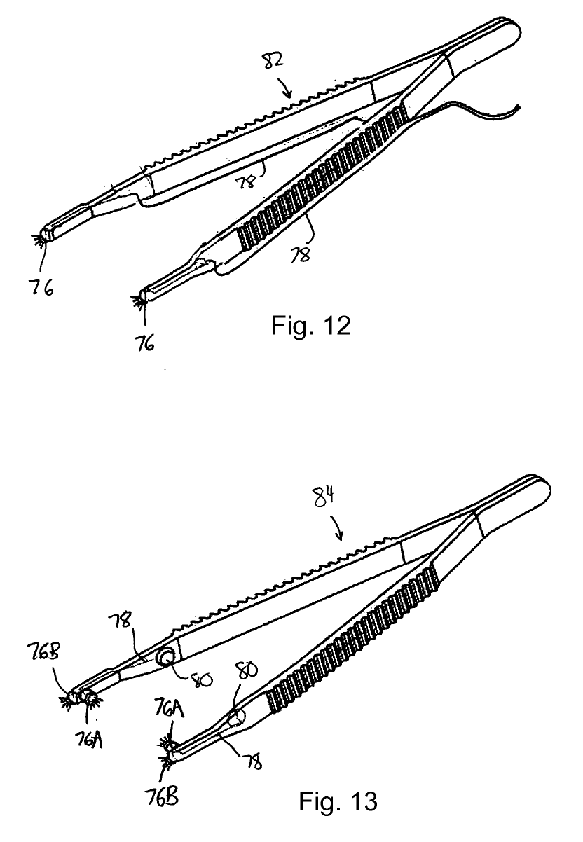

Batteries 80 could of course be omitted and replaced by leads 78 connectable to an external power supply as shown in FIG. 12. FIG. 12 also illustrates a configuration of a tweezers 82 wherein the LED's 76 are located on the tips or edges of arms 48. FIG. 13 is a battery operated pair of tweezers 84 similar to those of FIG. 10, but including both inwardly directed LED's 76A and edge LED's 76B on each arm 48.

The present invention thereby allows an orthodontist to initiate photo-curing of a light sensitive adhesive to adhere an attachment such as a bracket to a patient's tooth without the aid of an assistant to hold the light source used to initiate curing. Further, since the invention provides light sources that are positioned or positionable in close proximity to the adhesive, a smaller and/or less intense light source may be used for a shorter period of time. Light intensity on a surface, is a question of the intensity of the device and is related to the distance from the light source to the object. Placing the light on the bracket surface, or the edges of the tweezers or similar holding device, close to the tooth surface actually diminishes the fact of distance and therefore the intensity can be reduced to the minimum needed.

The present invention can also be used as form of illuminated decoration or jewelry worn on an outer surface of the front teeth. Such a decorative item 90 as shown in FIG. 15 includes a rectangular base 92 with light source (LED) 20, battery 26, leads 22 and a switch 94, for example, a pressure switch that the wearer can toggle on and off by pressing on the decoration 90 at that location. An optional raised design 96, colored pattern or the like receives light from LED 20 and is seen to shine when the mouth is opened. The background area 98 may be made opaque to provide better contrast. A blinking device or timer may be provided so that LED 20 flashes on and off an intervals. The adhesive used to adhere decoration 90 is preferably not of a permanent type. Even a simple bracket such as shown in FIG. 4 could be used for decorative effect if transparent and mounted on the outside of one of the wearer's front teeth, whether or not also used for orthodontics.

While the invention has been described with reference to illustrative embodiments, this description is not intended to be construed in a limiting sense. The described system can be used in other implantable medical devices such as prostheses or artificial body (e.g., artificial joints) wherein light-curable adhesives are used, or in industrial devices like pipes or construction blocks for use in curing adhesives. Other modifications and combinations of the illustrative embodiments will be apparent to persons skilled in the art upon reference to the description. Such variations and additions are specifically contemplated to be with the scope of the invention. It is intended that the appended claims encompass any such modifications or embodiments.

What is claimed is:

1. A method for bonding an orthodontic appliance to a tooth, the method comprising:
grasping an orthodontic appliance at distal ends of a pair of mechanical arms, wherein said orthodontic appliance has a light-sensitive adhesive disposed on a surface thereof;
placing said orthodontic appliance onto a surface of a tooth with said mechanical arms, wherein said adhesive contacts said tooth;
positioning photo-curing means in close proximity to said adhesive, said photo-curing means being disposed at any of said distal ends of said mechanical arms; and
photo-curing said adhesive with said photo-curing means.

2. A method according to claim 1 wherein said positioning of said photo-curing means comprises positioning a light source that emits light having a wavelength that is sufficient to cure said adhesive.

3. A method according to claim 2 wherein said wavelength is about 470 nm.
